(19) United States
(12) Patent Application Publication
(10) Pub. No.: US 2026/0340940 A1
(43) Pub. Date: Oct. 29, 2026

(54) AGGREGATED GEOGRAPHIC MAPS FOR INTEGRATING THIRD-PARTY GEOGRAPHIC DATA

(71) Applicant: Symmetry Software, LLC, Scottsdale, AZ (US)

(72) Inventors: Martin Sladok, Scottsdale, AZ (US); Thomas M. Reahard, Phoenix, AZ (US)

(21) Appl. No.: 19/193,826

(22) Filed: Apr. 29, 2025

(51) Int. Cl. G06T 17/05; G06F 16/29

(52) U.S. Cl. CPC G06T 17/05; G06F 16/29

(57) ABSTRACT

The online system generates an aggregated geographic map to enhance the collection and analysis of geographic data from various sources. This map stores geographic data in layers, each representing a specific metric type, such as altitude, terrain type, rainfall, population demographics, geopolitical boundaries, and tax rates and rules. The system aggregates metric values from geographic files into tiles covering the geographic area. The aggregated map UI allows users to display different layers and compute cumulative metric values at specific locations. The system can also identify optimized locations by applying an iterative process to the cumulative metric values. This approach simplifies the generation of user interfaces and cumulative metrics, improving the technical field of data aggregation and display.

### BACKGROUND

Many computing systems may store different data sets about a geographic area. For example, one computing system may store data describing population densities of regions within the area and another computing system may store data describing elevation of the terrain within the geographic area. The computing systems may make their data available to other computing systems to access. However, since the computing systems may be operated by different entities, the data sets may be disjointed and difficult to aggregate and compare. For example, for a computing system to compute a value for some metric over the whole geographic area, the computing system may need to rely on the data sets from different computing systems. However, the data sets for the different computing systems may use slightly different metrics for the data within their respective regions within the geographic area. Thus, computing systems looking to leverage data sets from multiple other computing systems to compute metrics for a geographic area struggle with the disjointed nature of those data sets.

### SUMMARY

An online system generates an aggregated geographic map to improve how geographic data from disparate sources are collected and analyzed. An aggregated geographic map is a data structure that stores geographic data for a geographic area in layers. Each of the layers stores metric values of a particular metric type. To generate these layers, the online system identifies geographic files that store metric values for the corresponding metric type and aggregates those metric values into tiles that cover the geographic area.

The online system uses this aggregated geographic map to generate an aggregated map UI to display on a requesting client device. The aggregated map UI includes a map UI element that displays the geographic area and layer UI elements that allow the user to display different layers on the map UI element. The aggregated map UI may further allow the user to indicate a location on the map UI element for computing a cumulative metric value. A cumulative metric value is a computed value that is generated based on metric values in the metric layers of the aggregated geographic map. For example, the cumulative metric value may be an urbanization score representing a level of urbanization at a location based on various demographic metrics stored in layers of the aggregated geographic map.

The aggregated map UI may also include a UI element for identifying candidate locations within the geographic area with optimized cumulative metric values. For example, the online system may identify a set of candidate locations in the geographic area and compute a cumulative metric value for each of the candidate locations. In some embodiments, the online system uses an iterative process (e.g., gradient descent) to identify and evaluate candidate locations near a starting location (e.g., an indicated location from a user). The online system may select which candidate locations to present to the user based on the cumulative metric values computed for each of the candidate locations.

By generating an aggregated geographic map based on geographic map data, the described online system improves on the technical field of aggregating data from different sources and displaying that in a unified way. In particular, the online system generates a particular data structure based on the different sets of data, which not only stores the data in a unified way but in a way that simplifies generating an user interface through which a user can access these different data sets. Furthermore, the aggregated geographic map allows for the simplified generation of cumulative metrics generated based on myriad sets of data.

### BRIEF DESCRIPTION OF THE DRAWINGS

FIG. 1 illustrates an example system environment for an online system, in accordance with one or more embodiments.

FIG. 2 is a flowchart for a method of generating an aggregated map user interface for displaying cumulative metric values, in accordance with some embodiments.

FIG. 3 illustrates an example aggregated map UI, in accordance with some embodiments.

FIG. 4 illustrates an example aggregated map UI displaying a cumulative metric value, in accordance with some embodiments.

FIG. 5 illustrates an example aggregated map UI displaying candidate locations with cumulative metric values, in accordance with some embodiments.

### DETAILED DESCRIPTION

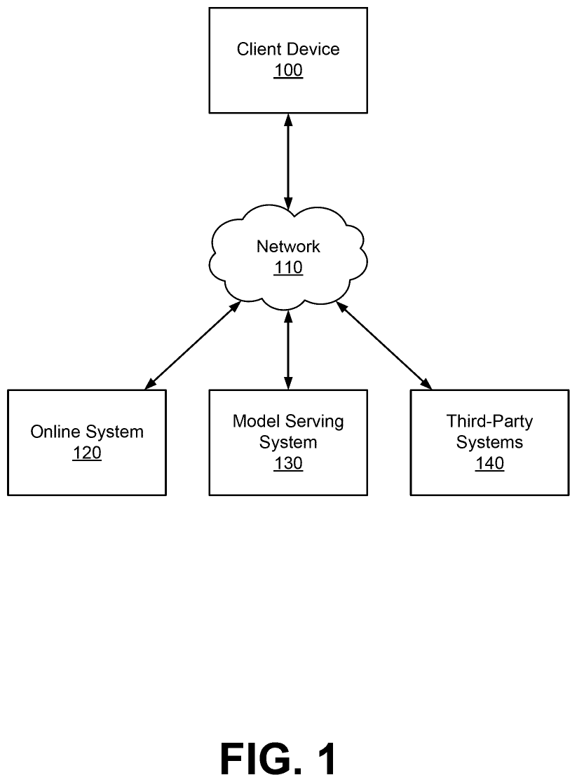

FIG. 1 illustrates an example system environment for an online system 120, in accordance with one or more embodiments. The system environment illustrated in FIG. 1 includes a client device 100, a network 110, an online system 120, and third party systems 130. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The user client device 100 is a client device through which a user may interact with the online system 120. The client device 100 can be a personal or mobile computing device, such as a smartphone, a tablet, a laptop computer, or desktop computer. In some embodiments, the user client device 100 executes a client application that uses an application programming interface (API) to communicate with the online system 120.

The user client device 100, the online system 120, and the third party systems 130 can communicate with each other via the network 110. The network 110 is a collection of computing devices that communicate via wired or wireless connections. The network 110 may include one or more local area networks (LANs) or one or more wide area networks (WANs). The network 110, as referred to herein, is an inclusive term that may refer to any or all of the standard layers used to describe a physical or virtual network, such as the physical layer, the data link layer, the network layer, the transport layer, the session layer, the presentation layer, and the application layer. The network 110 may include physical media for communicating data from one computing device to another computing device, such as multiprotocol label switching (MPLS) lines, fiber optic cables, cellular connections (e.g., 3G, 4G, or 5G spectra), or satellites. The network 110 also may use networking protocols, such as TCP/IP, HTTP, SSH, SMS, or FTP, to transmit data between computing devices. In some embodiments, the network 110 may include Bluetooth or near-field communication (NFC) technologies or protocols for local communications between computing devices. The network 110 may transmit encrypted or unencrypted data.

The online system and the client device may interact with third-party systems that store geographic data in geographic files for use by other computing systems. The geographic data may include information such as altitude, terrain type, rainfall, population demographics, geopolitical boundaries, and tax rates and rules. Entities that provide these third-party systems may include government agencies, academic institutions, and private companies specializing in geographic information systems (GIS) and spatial databases. Specific examples of such entities are Oracle Spatial, which offers enterprise-level spatial database solutions, and PostgreSQL with PostGIS extension, known for its performance in geospatial data management. These third-party systems and the use of their data is described in further detail below.

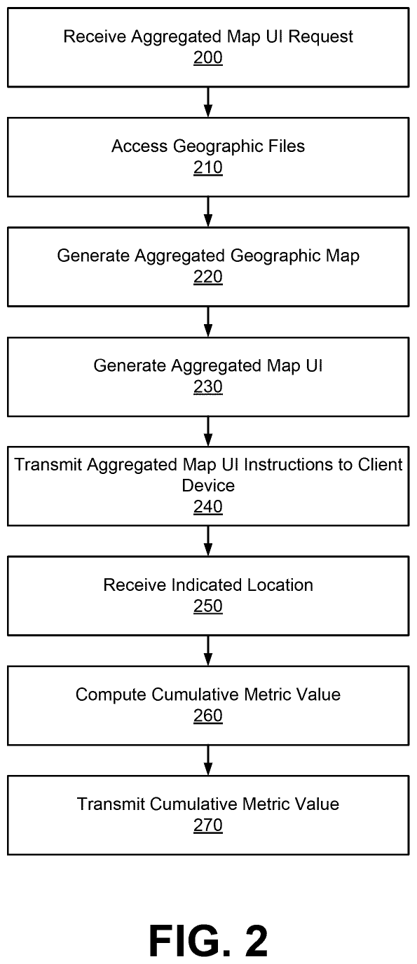

FIG. 2 is a flowchart for a method of generating an aggregated map user interface for displaying cumulative metric values, in accordance with some embodiments. Alternative embodiments may include more, fewer, or different steps from those illustrated in FIG. 2, and the steps may be performed in a different order from that illustrated in FIG. 2. These steps may be performed by an online system (e.g., online system 120). Additionally, each of these steps may be performed automatically by the online system without human intervention.

An online system receives 200 a request from a client device to generate an aggregated map UI. The request may include user data describing characteristics of the user, such as the user's location or demographic information.

To generate an aggregated map UI for the client device, the online system accesses 210 geographic file data that contains geographic files describing a geographic area. These geographic files describe the values for certain metrics tracked by the online system. For example, the metrics may describe characteristics of the geographic landscape of the geographic area, such as altitude, terrain type, or rainfall. The metrics may also track information about populations in the area, such as population, demographics, geopolitical boundaries, or tax rates and rules. The online system may access the geographic file data by receiving the data from one or more third-party systems that provide the geographic file data to other computing systems.

The geographic files specify the values for the set of metrics over the geographic area. The geographic files may describe the boundaries of a region within the geographic area and specify a value for a metric within that region. Similarly, the geographic files may divide the geographic area into portions and specify a value for a metric within each of the portions. In some embodiments, a geographic file includes multiple values for a metric on a certain point or region within the geographic area. For example, a geographic file may include multiple values for a precipitation metric within a geographic area, where those multiple values represent annual amounts of different types of precipitation (e.g., rain, snow, hail). Geographic files also may include values for multiple metrics, such as a file that contains values for multiple demographic metrics.

In some embodiments, each of the metrics described in the set of geographic files has a corresponding metric type. Metric types may be used by the online system to identify metrics that relate to each other (e.g., represent similar or the same underlying concept) but where the sources of the metrics are different or where the metrics correspond to different geographic regions. For example, one geographic area may have a flat income tax whereas another area may have different tax brackets based on income. These income tax metrics may be the same metric type, despite not being the same specific metric with directly comparable values. Similarly, one geographic file may contain values for a population density metric within a geographic area, whereas another geographic file may specify differently-sized areas with the same population. These metrics may have the same metric type.

The online system generates 220 an aggregated geographic map based on the accessed geographic files. To generate the aggregated geographic map, the online system generates a metric layer for each of the plurality of metric types. A metric layer represents the values of the metrics of a corresponding metric type over the geographic area. The metric layers store the metric values from the geographic files that store metric values for their corresponding metric types. The metric layers can thereby aggregate the metric values for metrics of the same metric type into a single representation.

To generate a metric layer, the online system identifies a subset of the geographic files that contain metric values for metrics of a corresponding metric type and generate the metric layer based on the metric values stored in the identified geographic files. The online system may generate the metric layer by generating a set of tiles for the metric layer. Each of the tiles may delineate a region within the geographic area and may include one or more metric values for the delineated region. Each of the tiles may be the same or similar size, such as regular rectangles or hexagons that cover the geographic area. Alternatively, the tiles may have different sizes or shapes from each other, such as depending on characteristics of the geographic area. In some embodiments, the size and shapes of the tiles in the metric layer are generated based on the size or shape of tiles in the geographic files that relate to metric values.

Each of the tiles has a corresponding metric value of a metric of the metric type for the metric layer. The metric values of the tiles are generated based on the metric values in the geographic files. For example, the online system may identify tiles in the geographic files that overlap with tiles in the metric layer and may average the metric values in overlapping tiles from the geographic files to generate the metric value for the tiles in the metric layer. In some embodiments, the online system weights the metric values from the geographic files based on an amount of overlap with the tiles in the metric layer.

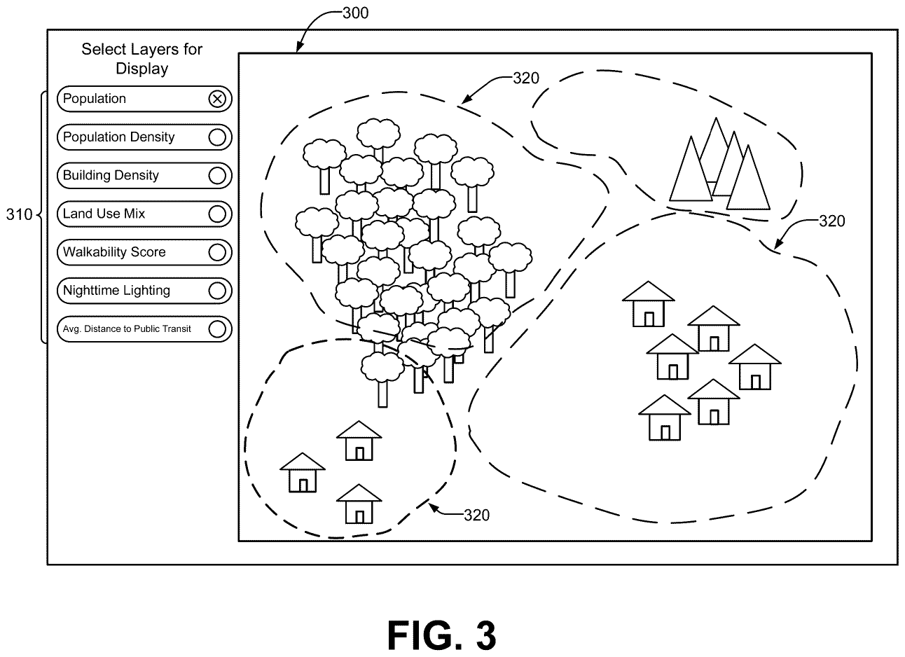

The online system generates 230 an aggregated map UI based on the generated aggregated map and transmits 240 computer-executable instructions to the client device to generate the aggregated map UI for display to the user. FIG. 3 illustrates an example aggregated map UI, in accordance with some embodiments. Alternative embodiments may include more, fewer, or different elements from those illustrated in FIG. 3.

The aggregated map UI includes a map UI element 300 that displays the geographic area. The user can select one or more layer UI elements 310 to display different layers on the map UI element. When a layer is selected, the aggregated map UI overlays the tiles 320 of the corresponding layer on the map UI element. Each tile may be displayed with another UI element that indicates the metric or metric value of the corresponding tile.

As noted above, the aggregated map UI includes a user interface element through which the user can indicate a location within the geographic area for generating a cumulative metric value at the indicated location. The online system receives 250 the indicated location from the client device and computes 260 a cumulative metric value at the indicated location.

A cumulative metric value is a computed value that is generated based on metric values in the metric layers of the aggregated geographic map. For example, the cumulative metric value may be a cumulative income tax rate at the indicated location based on the tax rates stored in the plurality of metric layers. The online system may generate the cumulative metric value for the indicated location by identifying a tile in each of the metric layers of the aggregated geographic map in which the indicated location is located. The online system may identify a metric value stored in each of the identified tiles from the metric layers and use the identified metric values to compute the cumulative metric value. The online system may compute the cumulative metric value by computing a weighted sum of the identified metric values based on a set of predetermined weights. Similarly, the online system may apply a set of rules to the identified metric values to compute the cumulative metric value. In some embodiments, the online system computes the identified metric value by applying a machine-learning model to the identified metric values.

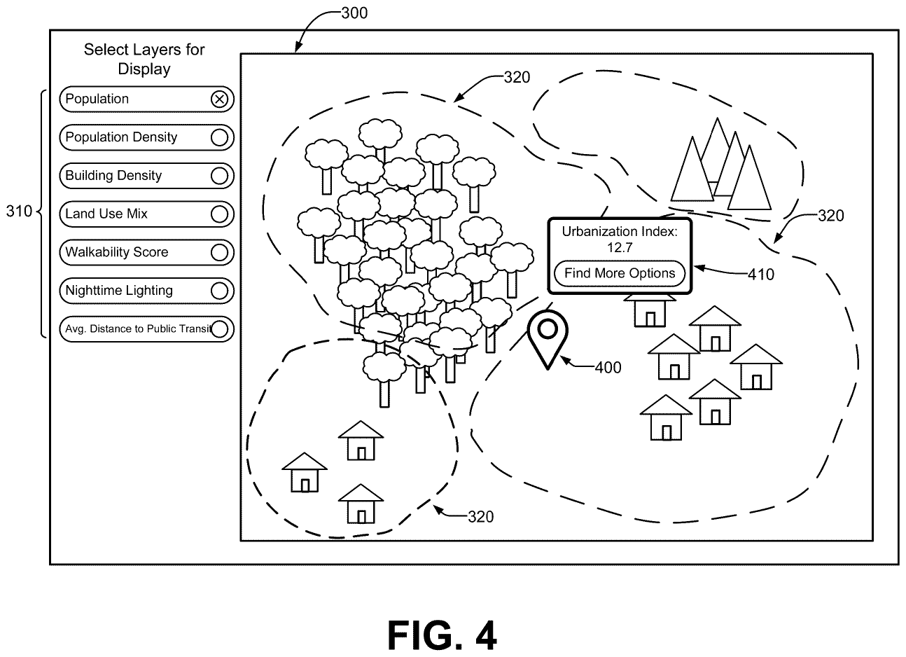

The online system transmits 270 the cumulative metric value to the client device for display to the user through the aggregated map UI. The aggregated map UI may display the cumulative metric value to the user through a user interface element near the indicated location. FIG. 4 illustrates an example aggregated map UI displaying a cumulative metric value, in accordance with some embodiments. The user can select or interact with a portion of the aggregated map UI to indicate a location 400 in the real geographic area. When the user makes the selection, the aggregated map UI updates the map UI element to includes a UI element that represents the indicated location. Additionally, the aggregated map UI may display a UI element 410 that displays a cumulative metric value calculated for the indicated location.

In some embodiments, the aggregated map UI includes a user interface element for identifying a location or area with an optimized cumulative metric value. For example, the online system may use the cumulative metric value as an objective function as part of an optimization process. The optimization process may include generating cumulative metric values at a set of candidate locations within the geographic area and selecting a candidate location with a cumulative metric value with an optimal (e.g., highest or lowest) metric value. In some embodiments, the online system performs an iterative process, such as a gradient descent process, to identify an optimal location based on previously computed cumulative metric values.

The online system may identify the location or area with an optimized cumulative metric value anywhere in the geographic area or may be limited based on other criteria. For example, the online system may use user data or user-provided criteria to identify candidate locations or areas for which to generate cumulative metric values for evaluation. In some embodiments, the online system uses an indicated location received from the user to identify a set of candidate locations to evaluate. For example, the online system may select a set of candidate locations that are within some threshold distance of the indicated location. Similarly, the online system may use the indicated location as a starting point for an iterative optimization process.

The online system selects one or more of the candidate locations based on their cumulative metric values and transmits the selected candidate locations to the client device for display to the user through the aggregated map UI. The aggregated map UI displays the received candidate location(s) to the user and may display the corresponding cumulative metric value along with the candidate location.

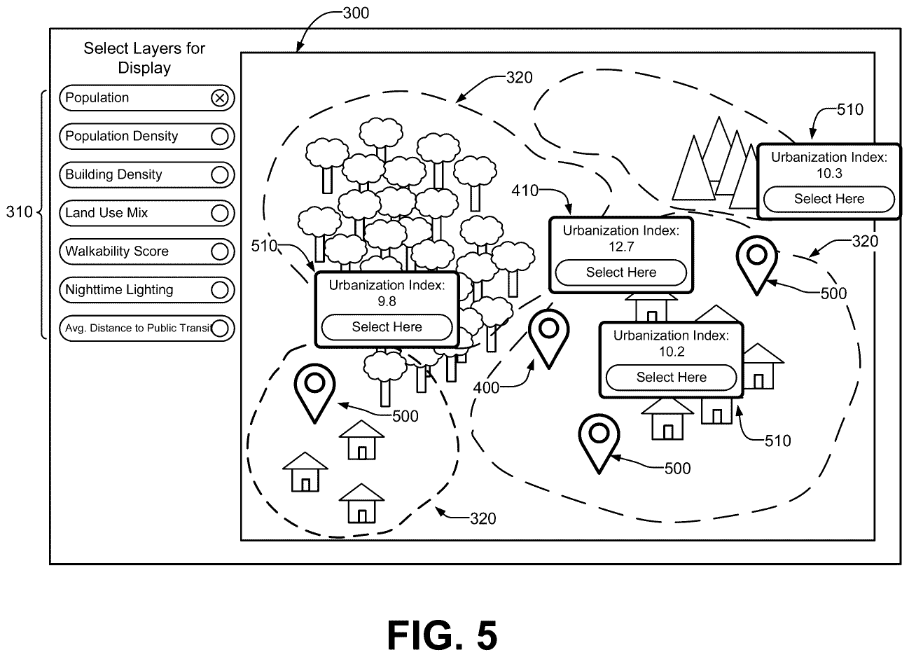

FIG. 5 illustrates an example aggregated map UI displaying candidate locations with cumulative metric values, in accordance with some embodiments. The aggregated map UI includes a UI element 500 for each of a set of candidate locations. The aggregated map UI may further include a UI element 510 that depicts the cumulative metric value for each of the candidate locations.

In some embodiments, the online system uses location data from the client device to track a cumulative metric value for the client device over time. For example, the online system may receive location data (e.g., GNSS data, IMU data, or magnetometer data) from the client device and identify a location of the client device based on the location data. The online system computes a cumulative metric value for the identified location using the process described above. The online system may regularly receive location data from the client device and use the location data to compute corresponding cumulative metric values. The online system may use the cumulative metric values from the set of locations to generate a total value for the client device. For example, the cumulative metric values may represent cumulative tax rates at different locations within the geographic area, and the online system may compute a total tax rate for the online system for the set of locations at which the client device has been located.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method comprising:
receiving a request for an aggregated map UI from a client device associated with a user of an online system;
accessing geographic file data comprising a plurality of geographic files, wherein each geographic file describes metric values for a metric of a plurality of metrics for a geographic area, wherein each of the plurality of metrics has a corresponding metric type of a plurality of metric types;
generating an aggregated geographic map based on the plurality of geographic files by generating a metric layer for each of the plurality of metric types, wherein generating a metric layer for a metric type of the plurality of metric types comprises:
identifying a subset of the plurality of geographic files containing metric values for metrics of the metric type; and
generating a metric layer for the metric type based on the identified subset of the plurality of geographic files, where the metric layer comprises a set of tiles that each indicate a geographic region within the geographic with an associated metric value;
generating an aggregated map UI for displaying the aggregated geographic map to the user through the client device, wherein the aggregated map UI comprises a map user interface element for viewing geographic information of the geographic region, a set of layer user interface elements for viewing each of the metric layers, and a user element for receiving indicated locations from the user;
transmitting computer-executable instructions to the client device for displaying the generated aggregated map UI to the user through the client device;
receiving an indicated location from the client device through the aggregated map UI, wherein the indicated location is a location within the geographic area;
computing a cumulative metric value for the indicated location based on the plurality of metric layers of the aggregated geographic map; and
transmitting the cumulative metric value to the client device for display through a user interface element located near the indicated location.

2. The method of claim 1, wherein accessing geographic file data comprises:
transmitting a request to a third-party system to access the geographic file data.

3. The method of claim 1, wherein one or more of the plurality of geographic files comprises metric values for more than one metric of the plurality of metrics.

4. The method of claim 1, wherein one or more of the plurality of geographic files describes a region within the geographic area corresponding to each metric value for a metric.

5. The method of claim 4, wherein each region comprises a plurality of metric values for the corresponding metric.

6. The method of claim 1, wherein each of the tiles of the set of tiles is a same shape or size as other tiles in the set of tiles.

7. The method of claim 1, further comprising:
receiving a selection of a layer user interface element of the set of layer user interface elements;
identifying a corresponding metric layer of the plurality of metric layers to the layer user interface element; and
updating the map user interface element to display or remove the set of tiles associated with the identified metric layer.

8. The method of claim 1, wherein the map user interface element is the user interface element for receiving indicated locations from the user.

9. The method of claim 1, further comprising:
receiving a selection through the aggregated map UI to identify candidate locations;
computing a cumulative metric value for each of a set of candidate locations within the geographic area;
selecting a subset of the set of candidate locations based on the computed cumulative metric values; and
displaying each of the selected candidate locations in the map user interface element of the aggregated map UI.

10. The method of claim 9, wherein selecting the subset of candidate locations comprises:
iteratively computing cumulative metric values for candidate locations within the geographic area.

11. The method of claim 10, wherein iteratively computing metric values for candidate locations comprises:
computing a metric value for a candidate location;
selecting a new candidate location based on the cumulative metric value for the candidate location; and
computing a cumulative metric value for the new candidate location.

12. The method of claim 11, wherein iteratively computing metric values for candidate locations comprises:
applying a gradient descent process.

13. The method of claim 1, further comprising:
tracking a location of a client device within the geographic area to generate a set of locations for the client device over a time period;
computing a cumulative metric value at each of the set of locations of the client device;
computing an aggregated metric value for the client device based on the computed metric values for the set of locations; and
transmitting the aggregated metric value to the client device.

14. A non-transitory computer-readable medium storing instructions that, when executed by a computer system, cause the computer system to perform operations comprising:
receiving a request for an aggregated map UI from a client device associated with a user of an online system;
accessing geographic file data comprising a plurality of geographic files, wherein each geographic file describes metric values for a metric of a plurality of metrics for a geographic area, wherein each of the plurality of metrics has a corresponding metric type of a plurality of metric types;
generating an aggregated geographic map based on the plurality of geographic files by generating a metric layer for each of the plurality of metric types, wherein generating a metric layer for a metric type of the plurality of metric types comprises:
identifying a subset of the plurality of geographic files containing metric values for metrics of the metric type; and
generating a metric layer for the metric type based on the identified subset of the plurality of geographic files, where the metric layer comprises a set of tiles that each indicate a geographic region within the geographic with an associated metric value;
generating an aggregated map UI for displaying the aggregated geographic map to the user through the client device, wherein the aggregated map UI comprises a map user interface element for viewing geographic information of the geographic region, a set of layer user interface elements for viewing each of the metric layers, and a user element for receiving indicated locations from the user;
transmitting computer-executable instructions to the client device for displaying the generated aggregated map UI to the user through the client device;
receiving an indicated location from the client device through the aggregated map UI, wherein the indicated location is a location within the geographic area;
computing a cumulative metric value for the indicated location based on the plurality of metric layers of the aggregated geographic map; and
transmitting the cumulative metric value to the client device for display through a user interface element located near the indicated location.

15. The computer-readable medium of claim 14, wherein accessing geographic file data comprises:
transmitting a request to a third-party system to access the geographic file data.

16. The computer-readable medium of claim 14, wherein one or more of the plurality of geographic files comprises metric values for more than one metric of the plurality of metrics.

17. The computer-readable medium of claim 14, wherein one or more of the plurality of geographic files describes a region within the geographic area corresponding to each metric value for a metric.

18. The computer-readable medium of claim 17, wherein each region comprises a plurality of metric values for the corresponding metric.

19. The computer-readable medium of claim 14, wherein each of the tiles of the set of tiles is a same shape or size as other tiles in the set of tiles.

20. The computer-readable medium of claim 14, the operations further comprising:
receiving a selection of a layer user interface element of the set of layer user interface elements;
identifying a corresponding metric layer of the plurality of metric layers to the layer user interface element; and
updating the map user interface element to display or remove the set of tiles associated with the identified metric layer.
